(19) United States
(12) Patent Application Publication
(10) Pub. No.: US 2021/0111480 A1
(43) Pub. Date: Apr. 15, 2021

(54) ELECTRONIC DEVICE

(71) Applicant: Molex, LLC, Lisle, IL (US)

(72) Inventors: Guang-Yong ZHONG, Shanghai (CN); Soon-Kuan TAN, Jurong Town (SG)

(73) Assignee: Molex, LLC, Lisle, IL (US)

(21) Appl. No.: 17/129,972

(22) Filed: Dec. 22, 2020

(30) Foreign Application Priority Data
Jan. 15, 2018 (CN) 201810035158.0

(51) Int. Cl. H01Q 1/24; G06F 1/16; H01Q 1/22; H01Q 13/10; H01Q 5/10

(52) U.S. Cl. CPC H01Q 1/243; G06F 1/1628; H01Q 5/10; H01Q 13/106; H01Q 1/2258

(57) ABSTRACT

The present disclosure provides an electronic device. The electronic device comprises a metal case, a slot antenna, a first dielectric material and a second dielectric material. The slot antenna is provided in the metal case and generates a signal. A dielectric constant of the second dielectric material is greater than a dielectric constant of the first dielectric material. The slot antenna comprises an electrical conductive member. The electrical conductive member is configured to define a slot which is closed at two ends thereof, the first dielectric material and the second dielectric material is provided in the slot, wherein the slot has a length, the length and the first dielectric material together determine that a high frequency band of the signal conforms to a high frequency band of a WIFI protocol, and the length and the first dielectric material together determine that a low frequency band of the signal is greater than a low frequency band of the WIFI protocol. The second dielectric material lowers the low frequency band of the signal to be within the low frequency band of the WIFI protocol. Because the second dielectric material is used, even if the slot antenna is positioned in the metal case, the slot antenna is still capable of generating a WIFI signal having two frequency bands.

### RELATED APPLICATION

This application claims the benefit of Chinese Application No. 201810035158.0, filed on Jan. 15, 2018, which is incorporated herein by reference in its entirety.

### TECHNICAL FIELD

The present disclosure relates to an electronic device, particularly relates to an electronic device having a metal case.

### BACKGROUND ART

At present, using a metal outer case as an outer case of a product is very popular in consumer electronics, such as iPHONE series or iMac computer, because the metal outer case may increase a strength of the product and provide good tactility for a user. However, if there is a metal material around an antenna, it would decrease efficacy of the antenna in radio frequency. Specifically, traditional antennas, such as a monopole antenna, an inverted-F antenna (IFA) and a planer-inverted-F antenna (PIFA), are not capable of operating at an all-metal outer case condition. The all-metal outer case condition refers to that most of the antenna is encircled by the metal outer case.

### SUMMARY

An embodiment of the present disclosure provides an electronic device. The electronic device comprises a metal case, a slot antenna, a first dielectric material and a second dielectric material. The slot antenna is provided in the metal case and generates a signal. A dielectric constant of the second dielectric material is greater than a dielectric constant of the first dielectric material. The slot antenna comprises an electrical conductive member. The electrical conductive member is configured to define a slot which is closed at two ends thereof, the first dielectric material and the second dielectric material is provided in the slot, wherein the slot has a length, the length and the first dielectric material together determine that a high frequency band of the signal conforms to a high frequency band of a WIFI protocol, and the length and the first dielectric material together determine that a low frequency band of the signal is greater than a low frequency band of the WIFI protocol. The second dielectric material lowers the low frequency band of the signal to be within the low frequency band of the WIFI protocol. Because the second dielectric material is used, even if the slot antenna is positioned in the metal case, the slot antenna is still capable of generating a WIFI signal having two frequency bands.

In an embodiment of the present disclosure, the second dielectric material is positioned in the slot at a provision position, wherein an electric field at the provision position at the high frequency band of the WIFI protocol is larger than or equal to a minimum electric field at the high frequency band of the WIFI protocol, and wherein an electric field at the provision position at the low frequency band of the WIFI protocol is less than or equal to a maximum electric field at the low frequency band of the WIFI protocol.

In an embodiment of the present disclosure, the second dielectric material is positioned in the slot at a provision position. The slot has a first position and a second position therein, an electric field at the first position is a minimum electric field at the high frequency band of the WIFI protocol, and an electric field at the second position is a maximum electric field at the low frequency band of the WIFI protocol, wherein the provision position is one of the first position, the second position and a position between the first position and the second position.

In an embodiment of the present disclosure, the first position and the second position are the same position.

In an embodiment of the present disclosure, the first dielectric material is air, the second dielectric material is plastic, glass or ceramics.

In an embodiment of the present disclosure, the first dielectric material is plastic, glass or ceramics.

In an embodiment of the present disclosure, a range of the high frequency band of the WIFI protocol is 5.15-5.85 GHz, and a range of the low frequency band of the WIFI protocol is 2.4-2.4835 GHz.

In an embodiment of the present disclosure, the slot antenna further comprises a feeding portion, the feeding portion indirectly feeds to the slot.

In an embodiment of the present disclosure, the slot antenna further comprises a feeding portion, the feeding portion directly feeds to the slot.

In an embodiment of the present disclosure, the dielectric constant of the first dielectric material is 1.0 F/m and the dielectric constant of the second dielectric material is 3.0 F/m.

In the embodiments of the present disclosure, by the length of the slot provided with the first dielectric material, the high frequency band of the signal conforms to the high frequency band of the WIFI protocol. Moreover, by that the dielectric constant of the second dielectric material is greater than the dielectric constant of the first dielectric material, the second dielectric material is used to lower the low frequency band of the signal to be within the low frequency band of the WIFI protocol. In addition, the present disclosure further provides a manner for designing a provision position of the second dielectric material so as to allow a lowered extent of the low frequency band of the signal to be relative large and allow a lowered extent of the high frequency band of the signal to be relative small. Hereby, the slot antenna provides a WIFI signal conforming to the WIFI protocol.

Relatively, some existing traditional antennas, such as a monopole antenna, an inverted-F antenna (IFA) and a planer-inverted-F antenna (PIFA), is not capable of operating at an all-metal outer case condition, that is, most of the antenna is encircled by the metal outer case. Even if the slot antenna is capable of operating at the all-metal outer case condition, based on antenna theory, a signal transmitted by the slot antenna is only capable of resonating at one frequency corresponding to a half wavelength of the signal. Therefore, the frequency band of the signal cannot meet two or more frequency bands required by the WIFI protocol.

Technical features and advantages of the present disclosure are widely summarized as above, so as to better understand the following detailed description. Other technical features making up technical solutions of the claims of the present disclosure and other advantages will be described below. A person skilled in the art of the present disclosure shall understand that the concept and specific embodiments disclosed below may be very easily used to modify or design other configuration or manufacturing approach so as to realize the same object as the present disclosure. A person skilled in the art of the present disclosure shall also understand that, such an equivalent configuration or approach cannot be departed from the spirit and scope of the present disclosure defined by the appended claims.

### BRIEF DESCRIPTION OF DRAWINGS

The various respects of the present disclosure may be best understood by the following detailed description taken in connection with the accompanying Figures. It should be noted that, according to a standard implementing mode of the industries, features are not drawn as the scale. In practice, for the sake of clear explanation, various features may be arbitrarily enlarged or reduced in dimension.

FIG. 1 is a schematic view of an electronic device of an embodiment of the present disclosure.

FIG. 2 is a partially enlarged schematic view of the electronic device of FIG. 1.

FIG. 3 is a schematic view of a slot antenna of the electronic device of FIG. 1.

FIG. 4 is a side schematic view of the slot antenna of FIG. 3.

FIG. 5 is a schematic view illustrating a position where an electric field is relative strong at a low frequency band of a WIFI protocol.

FIG. 6 is a schematic view illustrating a position where the electric field is relative strong at a high frequency band of the WIFI protocol and a position where the electric field is relative weak at the high frequency band of the WIFI protocol.

FIG. 7 is a schematic plot illustrating simulation results of the electronic device of FIG. 1.

FIG. 8 is a schematic view of another slot antenna of the embodiment of the present disclosure.

FIG. 9 is an exploded top perspective schematic view of the slot antenna of FIG. 8.

FIG. 10 is an exploded bottom perspective schematic view of the slot antenna of FIG. 8.

FIG. 11 is a schematic view of still another slot antenna of the embodiment of the present disclosure.

### DETAILED DESCRIPTION OF THE PREFERRED EMBODIMENTS

The following disclosed content provides various embodiments or exemplifications used to implement various features of the present disclosure. Specific examples of elements and arrangements are described as follows, so as to simplify the disclosed content of the present disclosure. Certainly, these are merely examples, and are not used to limit the present disclosure. For example, in the following description, that a first feature is formed on or above a second feature may comprise an embodiment that the first feature and the second feature are formed to directly contact each other, may also comprise an embodiment that other feature is formed between the first feature and the second feature, therefore the first feature and the second feature do not directly contact each other. Moreover, the present disclosure may allow a symbol and/or a character of an element to be repeated in different examples. The repetition is used for simplification and clearness, but is not used to dominate a relationship between various embodiments and/or discussed structures.

Moreover, the present disclosure may use spatial corresponding terminologies, such as “below”, “lower than”, “relative lower”, “higher than”, “relative high” and the like, so as to describe a relationship between an elements or feature and another element or feature. Spatial corresponding terminologies are used to comprise various orientations of a device in use or operation besides orientations illustrated in figures. The device may be orientated (rotated by 90 degrees or at other orientation), and the corresponding spatial description in the present disclosure may be correspondingly explained. It should be understood that, when a feature is formed to another feature or above a substrate, other feature may presented between them.

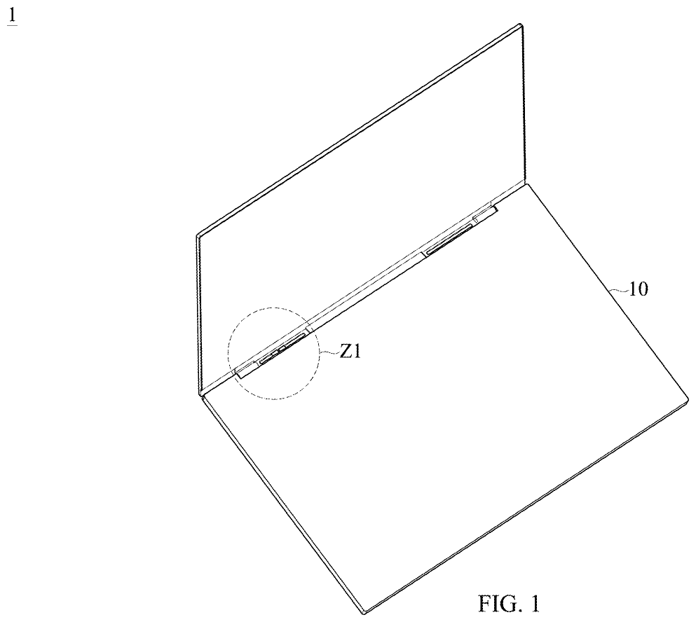

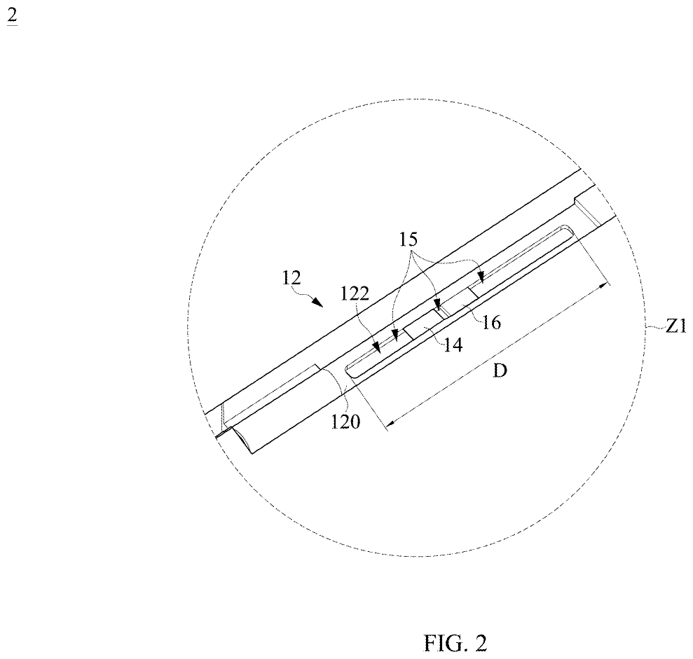

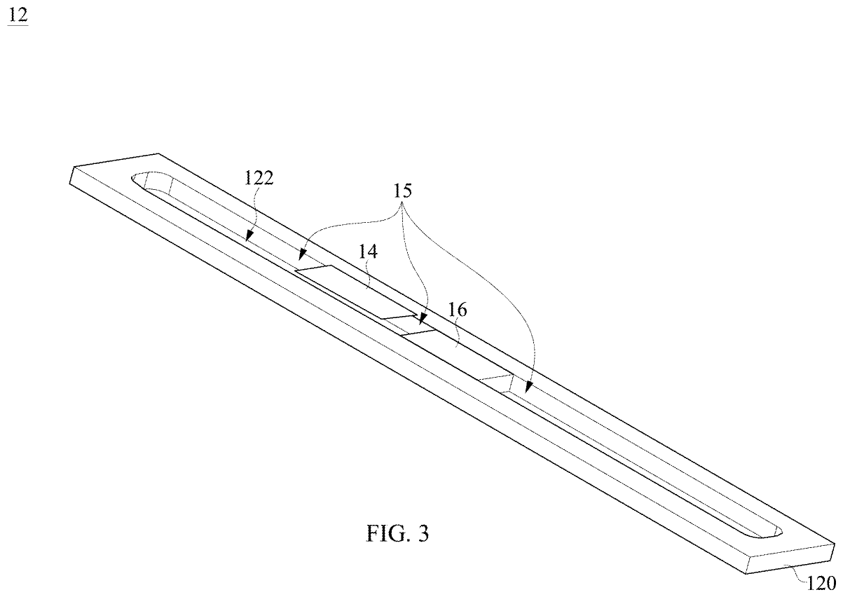

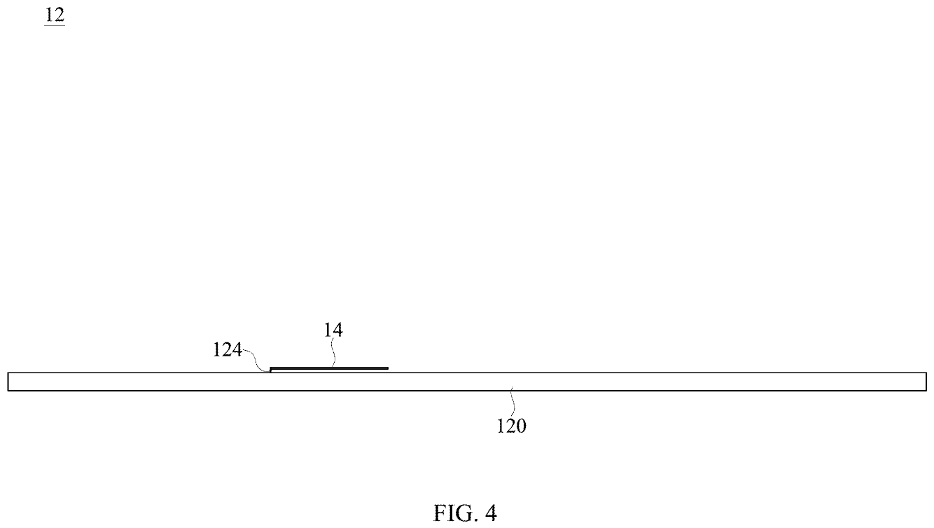

FIG. 1 is a schematic view of an electronic device 1 of an embodiment of the present disclosure. FIG. 2 is a partially enlarged schematic view of the electronic device 1 of FIG. 1 with respect to a region Z1. FIG. 3 is a schematic view of a slot antenna 12 of the electronic device 1 of FIG. 1. FIG. 4 is a side schematic view of the slot antenna 12 of FIG. 3. Referring to FIG. 1 to FIG. 4, the electronic device 1 comprises a metal case 10, a slot antenna 12, an antenna exciter 14, a first dielectric material 15 and a second dielectric material 16.

The slot antenna 12 is provided in the metal case 10 and is configured to generate a signal. The slot antenna 12 comprises an electrical conductive member 120 and a feeding portion 124.

The electrical conductive member 120 is configured to define a slot 122 which is closed at two ends thereof. The slot 122 has a length D. In some embodiments, the electrical conductive member 120 and the metal case 10 are formed as the same metal component by an integral forming process, the electrical conductive member 120 and the metal case 10 are different parts of the metal component. In some embodiments, electrical conductive member 120 is independent from the metal case 10 and assembled into the metal case 10.

The feeding portion 124 is positioned between the electrical conductive member 120 and the antenna exciter 14, as shown in FIG. 4. Hereby, the feeding portion 124 indirectly feeds to the slot 122. In an embodiment, a length of the feeding portion 124 is 0.3 millimeter (mm). Hereby, the antenna exciter 14 is essentially spaced apart from the electrical conductive member 120 by 0.3 mm. The antenna exciter 14 does not directly contact the electrical conductive member 120.

The antenna exciter 14 is provided in the slot antenna 12 and is configured to drive the slot antenna 12.

The first dielectric material 15 is provided in the slot 122 of the slot antenna 12. Specifically, the first dielectric material 15 fully fills a part of the slot 122 which is not occupied by the second dielectric material 16. In some embodiments, the first dielectric material 15 comprises air. In some embodiments, the first dielectric material 15 comprises plastic, glass or ceramics.

The second dielectric material 16 is provided in the slot 122 of the slot antenna 12. A dielectric constant of the second dielectric material 16 is greater than a dielectric constant of the first dielectric material 15. In some embodiments, the dielectric constant of the second dielectric material 16 is 3 Farad/meter (F/m). In some embodiments, when the first dielectric material 15 comprises air, the second dielectric material 16 comprises plastic, glass or ceramics.

In operation, the length D and the first dielectric material 15 together determine a range of a high frequency band of the signal and a range of a low frequency band of the signal. In the present embodiment, the length D is 49 millimeter (mm) and the first dielectric material 15 comprises air. Hereby, the length D and the first dielectric material 15 comprising air together determine that the high frequency band of the signal conforms to a high frequency band of a WIFI protocol and the low frequency band of the signal is greater than a low frequency band of the WIFI protocol, which will be described in detail later. In some embodiments, a range of the high frequency band of the WIFI protocol is 5.15-5.85 gigahertz (GHz), and a range of the low frequency band of the WIFI protocol is 2.4-2.4835 GHz.

By that the dielectric constant of the second dielectric material 16 is greater than the dielectric constant of the first dielectric material 15, the second dielectric material 16 is used to lower the low frequency band of the signal to be within the low frequency band of the WIFI protocol. Hereby, the slot antenna 12 is capable of generating a WIFI signal which conforms to the high frequency band and the low frequency band of the WIFI protocol at the same time. By the way, if the dielectric constant of the second dielectric material 16 is less than the dielectric constant of the first dielectric material 15, the first dielectric material 15 and the second dielectric material 16 possibly increase the low frequency band of the signal.

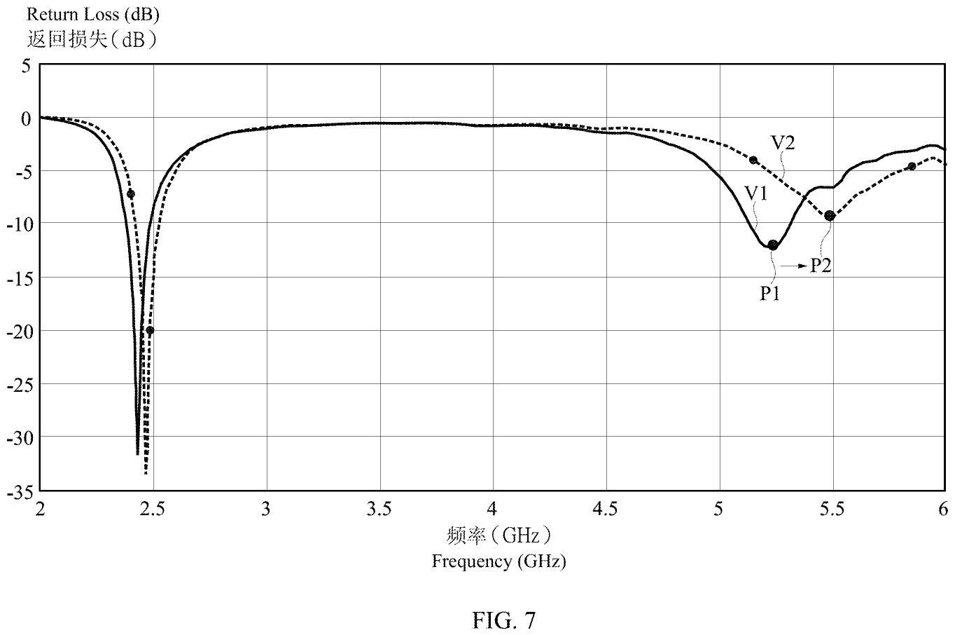

In some existing slot antennas, for sake of convenient understanding, the structure of the slot antenna 12 is taken as a reference for discussing the existing slot antenna as follows, the length of the slot 122 of the slot antenna 12 is 51 mm and the first dielectric material 15 comprises air. Under this case, a high frequency band of a signal generated by the slot antenna 12 does not conform to a requirement of the high frequency band of the WIFI protocol, which will be shown in the simulation result of FIG. 7.

In order to make the high frequency band of the signal generated by the slot antenna 12 conform to the requirement of the high frequency band of the WIFI protocol, a manner provided by the present disclosure increase a frequency of a high frequency resonance point of the signal. Specifically, the present disclosure does so by shortening the length D of the slot 122. In an embodiment, the length D of the slot 122 is shortened from 51 mm to 49 mm. However, the frequency of the high frequency resonance point is increased by shortening the length D of the slot 122 to conform to the requirement of the high frequency band of the WIFI protocol, at the same time a low frequency resonance point of the signal is also possibly increased therewith, thereby allowing that the low frequency band of the signal is possibly greater than the low frequency band of the WIFI protocol.

Hereby, the present disclosure proposes a design manner, in the design manner, by that the second dielectric material 16 having a relative high dielectric constant is provided in the slot 122, the low frequency resonance point of the signal is lowered, thereby allowing that the low frequency band of the signal is lowered to be within the low frequency band of the WIFI protocol. Thus the slot antenna 12 is capable of generating a WIFI signal having two frequency bands which respectively conform to the high frequency band and the low frequency band of the WIFI protocol.

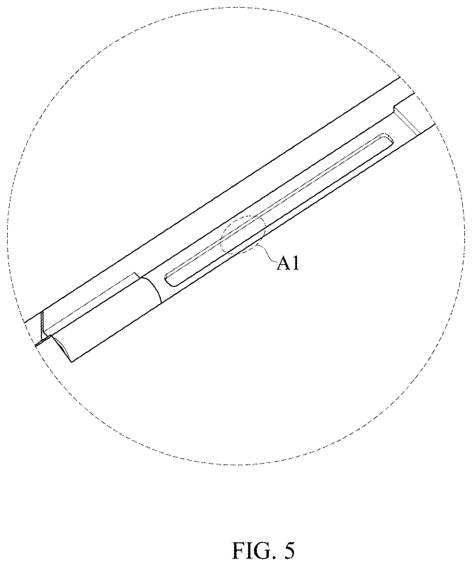

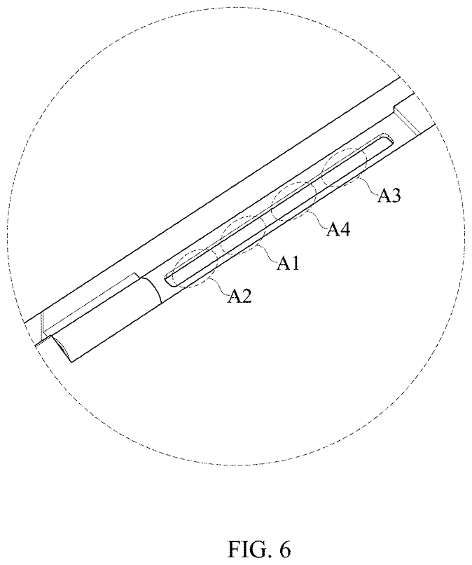

As described above, in the present disclosure, by that the second dielectric material 16 is added into the slot 122, the low frequency band of the signal is lowered to be within the low frequency band of the WIFI protocol. However, the high frequency band of the signal is also possibly lowered therewith. In order to allow a lowered extent of the low frequency band of the signal to be relative large and allow a lowered extent of the high frequency band of the signal to be relative small, the present disclosure additionally proposes a manner for designing the a provision position of the second dielectric material 16, it will be illustrated in detail in FIG. 5 and FIG. 6.

FIG. 5 is a schematic view illustrating a position where an electric field is relative strong at a low frequency band of a WIFI protocol. FIG. 6 is a schematic view illustrating a position where the electric field is relative strong at a high frequency band of the WIFI protocol and a position where the electric field is relative weak at the high frequency band of the WIFI protocol. In operation, the feeding portion 124 couples an electrical signal into the slot 122. Due to response to the electrical signal, an electric field is established. A strength of the electric field is positively associated with a changed extent of a resonance point of a frequency. For example, stronger the electric field is, larger the changed extent of the resonance point of the frequency is.

Referring to FIG. 5, at the low frequency band of the WIFI protocol, a region A1 of the electric field is relative strong. Hereby, if the second dielectric material 16 is provided in the region A1, the changed extent of the low frequency resonance point of the signal is relative large.

Referring to FIG. 6, at the high frequency band of the WIFI protocol, a region A2 and a region A3 of the electric field are relative strong. Hereby, if the second dielectric material 16 is provided in the region A2 and the region A3, the changed extent of the high frequency resonance point of the signal is relative large. Relatively, at the high frequency band of the WIFI protocol, a region A4 of the electric field is relative weak. Hereby, if the second dielectric material 16 is provided in the region A4, the changed extent of the high frequency resonance point of the signal is relative small.

In FIG. 5 and FIG. 6, the regions A1, A2, A3 and A4 are not used to describe an absolute relationship in position, but are used to describe a relative relationship in position. In some embodiments, the region A1 and the region A4 are independent from each other and are not overlapped with each other. In some embodiments, the region A1 and the region A4 are partially overlapped. In some embodiments, the region A1 and the region A4 are wholly overlapped.

As described with respect to the embodiment of FIG. 4, in order to allow the lowered extent of the low frequency band of the signal to be relative large and allow the lowered extent of the high frequency band of the signal to be relative small, the second dielectric material 16 may be provided in one of the region A1 (or may be referred to as a second position), the region A4 (or may be referred to as a first position) and a region between the region A1 and the region A4.

When the second dielectric material 16 is provided in the region A1, an electric field at the provision position of the second dielectric material 16 at the low frequency band of the WIFI protocol is equal to a maximum electric field at the low frequency band of the WIFI protocol, and an electric field at the provision position of the second dielectric material 16 at the high frequency band of the WIFI protocol is larger than a minimum electric field at the high frequency band of the WIFI protocol.

When the second dielectric material 16 is provided in the region between the region A1 and the region A4, an electric field at the provision position of the second dielectric material 16 at the low frequency band of the WIFI protocol is less than a maximum electric field at the low frequency band of the WIFI protocol, and an electric field at the provision position of the second dielectric material 16 at the high frequency band of the WIFI protocol is larger than a minimum electric field at the high frequency band of the WIFI protocol.

When the second dielectric material 16 is provided in the region A4, an electric field at the provision position of the second dielectric material 16 at the low frequency band of the WIFI protocol is less than a maximum electric field of the low frequency band of the WIFI protocol, and an electric field at the provision position of the second dielectric material 16 at the high frequency band of the WIFI protocol is equal to a minimum electric field at the high frequency band of the WIFI protocol.

In conclusion, the provision position of the second dielectric material 16 in an embodiment need meet two following conditions at the same time:

condition 1: an electric field at the provision position of the second dielectric material 16 at the high frequency band of the WIFI protocol is larger than or equal to a minimum electric field at the high frequency band of the WIFI protocol;
condition 2: an electric field at the provision position of the second dielectric material 16 at the low frequency band of the WIFI protocol is less than or equal to a maximum electric field at the low frequency band of the WIFI protocol.

FIG. 7 is a schematic plot illustrating simulation results of the electronic device 1 of FIG. 1. Referring to FIG. 7, a horizontal axis represents frequency, unit is gigahertz (GHz); and, a vertical axis represents return loss, unit is decibel (dB).

A curve line V1 represents characteristics of a signal generated by an existing slot antenna, in which the length of the slot of the existing slot antenna is 51 mm, the existing slot antenna does not have the second dielectric material 16 and the first dielectric material 15 comprises air. As can be seen from the curve line V1, the high frequency resonance point P1 of the signal is relative low, and the high frequency band of the signal does not conform to the high frequency band of the WIFI protocol.

A curve line V2 represents characteristics of another signal generated by the slot antenna 12, in which the length of the slot of the slot antenna 12 is 49 mm, the slot antenna 12 comprises the second dielectric material 16, the dielectric constant of the first dielectric material 15 is 1 (F/m) and the dielectric constant of the second dielectric material 16 is 3 (F/m). As can be seen from the curve line V2, the high frequency resonance point P2 of the another signal is relative high, and the high frequency band of the another signal conforms to the high frequency band of the WIFI protocol. Although the low frequency band of the another signal is relative high, the low frequency band of the another signal still conforms to the low frequency band of the WIFI protocol.

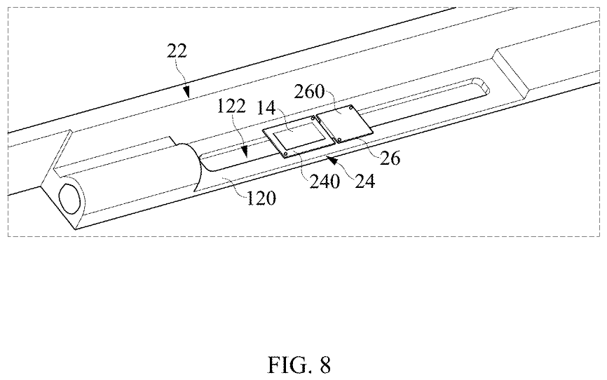

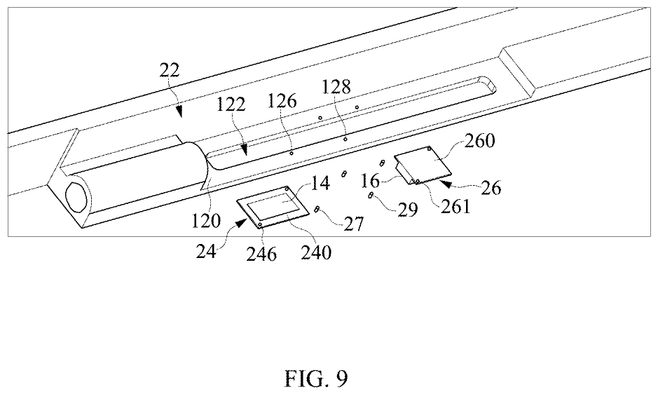

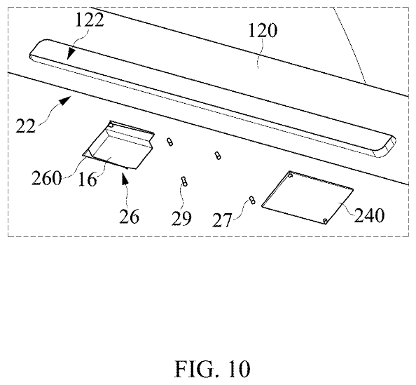

FIG. 8 is a schematic view of another slot antenna 22 of the embodiment of the present disclosure. FIG. 9 is an exploded top perspective schematic view of the slot antenna 22 of FIG. 8. FIG. 10 is an exploded bottom perspective schematic view of the slot antenna 22 of FIG. 8. Referring to FIG. 8 to FIG. 10, the slot antenna 22 is similar to the slot antenna 12 of FIG. 1 to FIG. 4, but is different in that the slot antenna 22 comprises an antenna exciter assembly 24 and a second dielectric material assembly 26.

The antenna exciter assembly 24 comprises an assembled component 240 and an antenna exciter 14. The antenna exciter 14 is mounted on an electrical conductive member 120 via the assembled component 240. Specifically, the assembled component 240 spans two sides of the slot 122, and by that a screw 27 passes through a mounting hole 246 in the assembled component 240 and a mounting hole 126 in the electrical conductive member 120 to allow the assembled component 240 to be fixed on the electrical conductive member 120. However, the present disclosure is not limited to such a mounting manner. In some embodiments, assembled component 240 also may be adhered onto the electrical conductive member 120 by an adhering manner.

The second dielectric material assembly 26 comprises an assembled component 260 and a second dielectric material 16. The second dielectric material 16 is mounted on the electrical conductive member 120 via the assembled component 260. Specifically, the assembled component 260 spans two sides of the slot 122, and by that a screw 29 passes through a mounting hole 261 of the assembled component 260 and a mounting hole 128 of the electrical conductive member 120 to allow the assembled component 260 to be fixed on the electrical conductive member 120. However, the present disclosure is not limited to such a mounting manner. In some embodiments, the assembled component 260 also may be adhered to the electrical conductive member 120 by an adhering manner. In some embodiments, the second dielectric material 16 and the assembled component 260 are members independent from each other. However, the present disclosure is not limited thereto. In some embodiments, the second dielectric material 16 and the assembled component 260 is formed as the same member by an integral forming process, the second dielectric material 16 and the assembled component 260 are different parts of the same member.

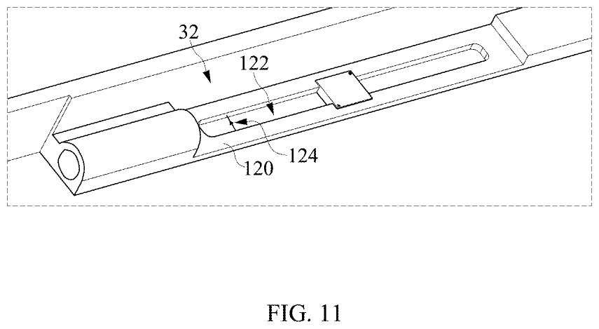

FIG. 11 is a schematic view of still another slot antenna 32 of the embodiment of the present disclosure. Referring to FIG. 11, the slot antenna 32 is similar to the slot antenna 22 of FIG. 8, but is different in that the slot antenna 32 does not have the antenna exciter 14. Two ends of the feeding portion 124 directly span two sides of the slot 122. Hereby, the feeding portion 124 directly feeds to the slot 122. In some embodiments, the assembled component 260 of the slot antenna 32 may be provided on the electrical conductive member 120 by a screwing manner or an adhering manner. In some embodiments, the second dielectric material 16 and the assembled component 260 of the slot antenna 32 are members independent from each other. However, the present disclosure is not limited thereto. In some embodiments, the second dielectric material 16 and the assembled component 260 are formed as the same member by an integral forming process, the second dielectric material 16 and the assembled component 260 are different parts of the same member.

Features of some embodiments are summarized in above content, so that a person skilled in the art may better understand various aspects of the disclosed content of the present disclosure. A person skilled in the art of the present disclosure shall understand that the disclosed content of the present disclosure may be easily used to design or modify other manufacturing approach or configuration and in turn to realize the same object and/or attain the same advantage as the embodiments of the present disclosure. A person skilled in the art of the present disclosure shall also understand that, such an equivalent approach or configuration cannot be departed from the spirit and scope of the disclosed content of the present disclosure, and a person skilled in the art may make various changes, substitutions and replacements, which are not departed from the spirit and scope of the disclosed content of the present disclosure.

What is claimed is:

1. An electronic device, comprising:
a metal case;
a first dielectric material;
a second dielectric material, a dielectric constant of the second dielectric material being greater than a dielectric constant of the first dielectric material; and
a slot antenna provided in the metal case and generating a signal, the slot antenna comprising:
an electrical conductive member configured to define a slot which is closed at two ends thereof, the first dielectric material and the second dielectric material being provided in the slot, wherein the slot has a length, the length and the first dielectric material together determine that a high frequency band of the signal conforms to a high frequency band of a WIFI protocol, and the length and the first dielectric material together determine that a low frequency band of the signal is greater than a low frequency band of the WIFI protocol,
wherein the second dielectric material lowers the low frequency band of the signal to be within the low frequency band of the WIFI protocol.

2. The electronic device of claim 1, wherein the second dielectric material is positioned in the slot at a provision position,
wherein an electric field at the provision position at the high frequency band of the WIFI protocol is larger than or equal to a minimum electric field at the high frequency band of the WIFI protocol, and
wherein an electric field at the provision position at the low frequency band of the WIFI protocol is less than or equal to a maximum electric field at the low frequency band of the WIFI protocol.

3. The electronic device of claim 1, wherein the second dielectric material is positioned in the slot at a provision position,
wherein the slot has a first position and a second position therein, an electric field at the first position is a minimum electric field at the high frequency band of the WIFI protocol, and an electric field at the second position is a maximum electric field at the low frequency band of the WIFI protocol,
wherein the provision position is one of the first position, the second position and a position between the first position and the second position.

4. The electronic device of claim 3, wherein the first position and the second position are the same position.

5. The electronic device of claim 1, wherein the first dielectric material is air, the second dielectric material is plastic, glass or ceramics.

6. The electronic device of claim 1, wherein the first dielectric material is plastic, glass or ceramics.

7. The electronic device of claim 1, wherein a range of the high frequency band of the WIFI protocol is 5.15-5.85 GHz, and a range of the low frequency band of the WIFI protocol is 2.4-2.4835 GHz.

8. The electronic device of claim 1, wherein the slot antenna further comprises a feeding portion, the feeding portion indirectly feeds to the slot.

9. The electronic device of claim 1, wherein the slot antenna further comprises a feeding portion, the feeding portion directly feeds to the slot.

10. The electronic device of claim 1, wherein the dielectric constant of the first dielectric material is 1.0 F/m and the dielectric constant of the second dielectric material is 3.0 F/m.
